(19) United States
(12) Patent Application Publication
(10) Pub. No.: US 2026/0132296 A1
(43) Pub. Date: May 14, 2026

(54) CALCIUM-MAGNESIUM COMPOSITE FIREPROOF AND FLAME-RETARDANT MATERIAL, PREPARATION METHOD AND APPLICATIONS THEREOF, AND FLAME-RESISTANT OPTICAL/ELECTRICAL CABLE AND PREPARATION METHOD THEREOF

(71) Applicant: Fuzhou University, Fuzhou (CN)

(72) Inventors: Yan YU, Fuzhou (CN); Kongjian CHEN, Fuzhou (CN); Chenggong YUAN, Fuzhou (CN); Feifei CHEN, Fuzhou (CN)

(73) Assignee: Fuzhou University, Fuzhou (CN)

(21) Appl. No.: 18/974,854

(22) Filed: Dec. 10, 2024

(30) Foreign Application Priority Data
Nov. 11, 2024 (CN) 202411601437.0

(51) Int. Cl. C09D 5/18; C08K 3/22; C08K 11/00; C09D 5/02; C09D 7/40; C09D 7/61; C09D 7/80; C09D 131/04; G02B 6/44; H01B 7/295

(52) U.S. Cl. CPC C09D 5/18; C09D 5/022; C09D 5/028; C09D 7/61; C09D 7/69; C09D 7/80; C09D 131/04; G02B 6/4436; H01B 7/295; C08K 2003/2224; C08K 11/00; C08K 2201/005

(57) ABSTRACT

A calcium-magnesium composite fireproof and flame-retardant material, a preparation method and applications thereof, and a flame-resistant optical/electrical cable and a preparation method thereof are provided. The present disclosure only uses water as a solvent, VAE latex as a polymer matrix, a biomass calcium material and magnesium hydroxide as fillers, and the raw materials have low price and are easy to obtain. The calcium-magnesium composite fireproof and flame-retardant material has excellent flame retardancy and mechanical strength. The present disclosure utilizes the layered structure of the biomass calcium material, a gas generation mechanism, stable thermal decomposition products, and excellent mechanical properties, and can effectively enhance the flame retardancy and mechanical properties of the calcium-magnesium composite fireproof and flame-retardant material. The present disclosure enhances the flame-retardant performance, tensile strength and tensile rate of the calcium-magnesium composite fireproof and flame-retardant material through a synergistic effect of magnesium hydroxide and biomass calcium material.

### CROSS REFERENCE TO THE RELATED APPLICATIONS

This application is based upon and claims priority to Chinese Patent Application No. 202411601437.0, filed on Nov. 11, 2024, the entire contents of which are incorporated herein by reference.

### TECHNICAL FIELD

The present disclosure relates to the technical field of flame-retardant materials, and in particular, to a calcium-magnesium composite fireproof and flame-retardant material, a preparation method and applications thereof, and a flame-resistant optical/electrical cable and a preparation method thereof.

### BACKGROUND

The application scenarios of optical (electrical) cables put forward higher requirements for safety, flame retardancy and mechanical properties. At present, a flame-retardant and fire-resistant communication optical (electrical) cable contains a conductor, an insulating layer, a fireproof and flame-retardant tape and so on, and a more mature flame-retardant tape on the market uses magnesium hydroxide as a main raw material. Due to the low flame-retardant efficiency of magnesium hydroxide, the flame-retardant effect can only be achieved when a filling amount reaches more than 60%, which affects the mechanical properties and processing properties of the tape and electrical cable. The Chinese patent CA118562200A points out that the compatibility between magnesium hydroxide and the polymer is poor, with a constrained addition, which makes it difficult to guarantee the mechanical properties of the composite material. The Chinese patent CN114318910A1 discloses a processing technology procedure for a halogen-free low-smoke filling rope for electrical cables, and raw materials include the following mass percentage components: magnesium hydroxide 30-60%, vinyl acetate-ethylene (VAE) emulsion 10-40%, and the rest is water. However, although the above raw materials carry out coating by using magnesium hydroxide, the mechanical properties and processing properties of the tape are not significantly improved.

### SUMMARY

In view of this, an objective of the present disclosure is to provide a calcium-magnesium composite fireproof and flame-retardant material, a preparation method and applications thereof, and a flame-resistant optical/electrical cable and a preparation method thereof. The calcium-magnesium composite fireproof and flame-retardant material provided by the present disclosure has excellent flame retardancy and mechanical strength, and is low-cost.

To achieve the objective of the present disclosure, the present disclosure provides the following technical solutions:

The present disclosure provides a calcium-magnesium composite fireproof and flame-retardant material, measured by weight parts, including raw materials: a biomass calcium material 1-10 phr, magnesium hydroxide 1-10 phr, VAE latex 2-8 phr, and 10-30 phr water.

Preferably, the biomass calcium material includes one or more of a shell, an oyster shell and an eggshell;
the biomass calcium material is crushed and dried before use, to obtain biomass calcium material powder; and
a particle size of the biomass calcium material powder is 40-200 m.

The present disclosure provides a preparation method of the calcium-magnesium composite fireproof and flame-retardant material described in the above technical solutions, including the following steps: mixing raw materials, to obtain a mixed solution, and drying the mixed solution, to obtain the calcium-magnesium composite fireproof and flame-retardant material.

Preferably, the mixing includes an ultrasonic mixing or a stirring mixing;
preferably, a time of the ultrasonic mixing is 20-40 min, and power is 20-100 W; and
a time of the stirring mixing is 30-90 min, and a speed is 200-800 r/min.

Preferably, a drying temperature is 60-100° C.

The present disclosure provides applications of the calcium-magnesium composite fireproof and flame-retardant material described in the above technical solutions or the calcium-magnesium composite fireproof and flame-retardant material prepared by the preparation method described in the above technical solutions in a tape of optical cable or a tape of electrical cable.

The present disclosure provides a flame-resistant optical/electrical cable, including a matrix and the calcium-magnesium composite fireproof and flame-retardant material coated on a surface of the matrix; and the matrix includes an optical cable or an electrical cable.

The present disclosure provides a preparation method of the flame-resistant optical/electrical cable described in the above technical solutions, including the following steps: mixing raw materials for preparing the calcium-magnesium composite fireproof and flame-retardant material described in the above technical solutions, to obtain a mixed solution, coating the mixed solution on a matrix and then drying, to obtain the flame-resistant optical/electrical cable.

Preferably, the mixing includes an ultrasonic mixing or a stirring mixing;
preferably, a time of the ultrasonic mixing is 20-40 min, and power is 20-100 W; and
a time of the stirring mixing is 30-90 min, and a speed is 200-800 r/min.

Preferably, a drying temperature is 60-100° C.

The present disclosure provides a calcium-magnesium composite fireproof and flame-retardant material, measured by weight parts, and a preparation of raw materials includes: a biomass calcium material 1-10 phr, magnesium hydroxide 1-10 phr, VAE latex 2-8 phr, and 10-30 phr water. The present disclosure only uses water as a solvent, VAE latex as a polymer matrix, a biomass calcium material and magnesium hydroxide as fillers, and the raw materials have low price and are easy to obtain. The calcium-magnesium composite fireproof and flame-retardant material has excellent flame retardancy and mechanical strength. Specifically, the present disclosure effectively combines the calcium-magnesium composite fireproof and flame-retardant material with glass fiber by adding VAE latex as a polymer matrix. The present disclosure enhances the flame-retardant performance, tensile strength and tensile rate of the calcium-magnesium composite fireproof and flame-retardant material through a synergistic effect of magnesium hydroxide and biomass calcium material. Usually, biomass calcium is a unique layered structure constructed from calcium carbonate and organic molecules; at high temperatures, calcium carbonate can be decomposed into calcium oxide and carbon dioxide, releasing carbon dioxide gas and generating calcium oxide, carbon dioxide dilutes the combustion-supporting gas, thereby slowing the combustion rate, and calcium oxide serves as a protective layer to isolate the transfer of heat and gas; and the unique layered structure of the biomass calcium material can endow the material with good strength and toughness. The present disclosure utilizes the layered structure of the biomass calcium material, a gas generation mechanism, stable thermal decomposition products, and excellent mechanical properties, and can effectively enhance the flame retardancy and mechanical properties of the calcium-magnesium composite fireproof and flame-retardant material. Moreover, biomass calcium is a solid waste, its raw materials are easy to obtain and the price is low, and the cost of the calcium-magnesium composite fireproof and flame-retardant material is low.

A preparation method of the calcium-magnesium composite fireproof and flame-retardant material provided by the present disclosure has a simple process flow, and raw materials are easy to obtain and low-cost, environmentally friendly, and low production cost, which is suitable for industrial production.

### DETAILED DESCRIPTION OF THE EMBODIMENTS

The present disclosure provides a calcium-magnesium composite fireproof and flame-retardant material, measured by weight parts, and raw materials include: a biomass calcium material 1-10 phr, magnesium hydroxide 1-10 phr, VAE latex 2-8 phr, and 10-30 phr water.

If there is no special description, the materials and equipment used in the present disclosure are all commercially available products in this field.

Measured by weight parts, raw materials for preparing the calcium-magnesium composite fireproof and flame-retardant material provided by the present disclosure include the biomass calcium material 1-10 phr, which can be 1 phr, 2 phr, 3 phr, 4 phr, 5 phr, 6 phr, 7 phr, 8 phr, 9 phr or 10 phr in the embodiments of the present disclosure.

In the present disclosure, the biomass calcium material includes one or more of a shell, an oyster shell and an eggshell. In the present disclosure, the biomass calcium material is crushed and dried before use, to obtain biomass calcium material powder. In the present disclosure, a particle size of the biomass calcium material powder is preferably 40-200 μm, which can be 40 μm, 50 μm, 60 μm, 70 μm, 80 μm, 90 μm, 100 μm, 110 μm, 120 μm, 130 μm, 140 μm, 150 μm, 160 μm, 170 am, 180 μm, 190 μm or 200 μm in the embodiments of the present disclosure.

The biomass calcium material used in the present disclosure has a unique layered structure constructed by calcium carbonate and organic molecules. At high temperatures, calcium carbonate can be decomposed into calcium oxide and carbon dioxide, releasing carbon dioxide gas and generating calcium oxide, carbon dioxide dilutes the combustion-supporting gas, thereby slowing the combustion rate, and calcium oxide serves as a protective layer to isolate the transfer of heat and gas. Moreover, the unique layered structure of the biomass calcium material can endow the calcium-magnesium composite fireproof and flame-retardant material with good strength and toughness.

In the present disclosure, the crushing preferably includes ball milling, and a ball milling time is preferably 5-16 h, which can be 5 h, 6 h, 7 h, 8 h, 9 h, 10 h, 11 h, 12 h, 13 h, 14 h, 15 or 16 h in the embodiments of the present disclosure; and a rotational speed of the ball milling is preferably 200-700 r/min, which can be 200 r/min, 250 r/min, 300 r/min, 350 r/min, 400 r/min, 450 r/min, 500 r/min, 550 r/min, 600 r/min, 650 r/min or 700 r/min in the embodiments of the present disclosure.

In the present disclosure, the drying preferably includes one or more of room temperature drying, atmospheric pressure heating drying, vacuum heating drying and freeze-drying. In the present disclosure, a temperature of the room temperature drying is preferably room temperature, and a time of the room temperature drying is preferably 10-24 h, which can be 10 h, 11 h, 12 h, 13 h, 14 h, 15 h, 16 h, 17 h, 18 h, 19 h, 20 h, 21 h, 22 h, 23 h, or 24 h in the embodiments of the present disclosure. In the present disclosure, a temperature of the atmospheric pressure heating drying is preferably 50-80° C., which can be 50° C., 55° C., 60° C., 65° C., 70° C., 75° C., or 80° C. in the embodiments of the present disclosure; a time of the atmospheric pressure heating drying is preferably 5-12 h, which can be 5 h, 6 h, 7 h, 8 h, 9 h, 10 h, 11 h, and 12 h in the embodiments of the present disclosure. In the present disclosure, a temperature of the vacuum heating drying is preferably 50-80° C., which can be 50° C., 55° C., 60° C., 65° C., 70° C., 75° C., or 80° C. in the embodiments of the present disclosure; and a time of the vacuum heating drying is preferably 5-12 h, which can be 5 h, 6 h, 7 h, 8 h, 9 h, 10 h, 11 h, and 12 h in the embodiments of the present disclosure. In the present disclosure, a temperature of the freeze-drying is preferably −50° C.-−80° C., which can be −50° C., −60° C., −70° C., or −80° C. in the embodiments of the present disclosure; and a time of the freeze-drying is preferably 10-24 h, which can be 10 h, 11 h, 12 h, 13 h, 14 h, 15 h, 16 h, 17 h, 18 h, 19 h, 20 h, 21 h, 22 h, 23 h, or 24 h in the embodiments of the present disclosure.

Measured by weight part of the biomass calcium material powder, the raw materials for preparing the calcium-magnesium composite fireproof and flame-retardant material provided by the present disclosure include magnesium hydroxide 1-10 phr, which can be 1 phr, 2 phr, 3 phr, 4 phr, 5 phr, 6 phr, 7 phr, 8 phr, 9 phr or 10 phr in the embodiments of the present disclosure. The present disclosure enhances the flame-retardant performance, tensile strength and tensile rate of the calcium-magnesium composite fireproof and flame-retardant material through a synergistic effect of the magnesium hydroxide and the biomass calcium material.

Measured by weight part of the biomass calcium material powder, the raw materials for preparing the calcium-magnesium composite fireproof and flame-retardant material provided by the present disclosure include VAE latex 2-8 phr, which can be 2 phr, 3 phr, 4 phr, 5 phr, 6 phr, 7 phr, or 8 phr in the embodiments of the present disclosure. The present disclosure effectively combines calcium-magnesium composite fireproof and flame-retardant material with glass fiber by adding VAE latex as a polymer matrix.

Measured by weight part of the biomass calcium material powder, the raw materials for preparing the calcium-magnesium composite fireproof and flame-retardant material provided by the present disclosure include water 10-30 phr, which can be 10 phr, 11 phr, 12 phr, 13 phr, 14 phr, 15 phr, 16 phr, 17 phr, 18 phr, 19 phr, 20 phr, 21 phr, 22 phr, 23 phr, 24 phr, 25 phr, 26 phr, 27 phr, 28 phr, 29 phr, or 30 phr in the embodiments of the present disclosure.

The present disclosure further provides a preparation method of the calcium-magnesium composite fireproof and flame-retardant material, including the following steps: raw materials are mixed, to obtain a mixed solution, and the mixed solution is dried, to obtain the calcium-magnesium composite fireproof and flame-retardant material.

In the present disclosure, the mixing preferably includes an ultrasonic mixing or a stirring mixing; and a mixing temperature is preferably room temperature.

In the present disclosure, a time of the ultrasonic mixing is preferably 20-40 min, which can be 20 min, 25 min, 30 min, 35 min, or 40 min in the embodiments of the present disclosure; and power of the ultrasonic mixing is preferably 20-100 W, which can be 20 W, 30 W, 40 W, 50 W, 60 W, 70 W, 80 W, 90 W, or 100 W in the embodiments of the present disclosure.

In the present disclosure, a time of the stirring mixing is preferably 30-90 min, which can be 30 min, 35 min, 40 min, 45 min, 50 min, 55 min, 60 min, 65 min, 70 min, 75 min, 80 min, 85 min, or 90 min in the embodiments of the present disclosure; and a speed of the stirring mixing is preferably 200-800 r/min, which can be 200 r/min, 250 r/min, 300 r/min, 350 r/min, 400 r/min, 450 r/min, 500 r/min, 550 r/min, 600 r/min, 650 r/min, 700 r/min, 750 r/min, 800 r/min, 850 r/min, or 900 r/min in the embodiments of the present disclosure. In the present disclosure, the stirring mixing preferably includes a magnetic stirring or a mechanical stirring.

The present disclosure uses a physical mixing to make the biomass calcium material powder and magnesium hydroxide uniformly mixed, avoiding an agglomeration of magnesium hydroxide and the biomass calcium material powder, and the flame retardant properties, tensile strength and tensile rate of the calcium-magnesium composite fireproof and flame-retardant material are enhanced by a synergistic effect of magnesium hydroxide and the biomass calcium material.

In the present disclosure, a drying temperature is preferably 60-100° C., which can be 60° C., 65° C., 70° C., 75° C., 80° C., 95° C., 90° C., 95° C., or 1000° C. in the embodiments of the present disclosure; and a drying time is preferably >2 min, and more preferably 2-10 min, which can be 2 min, 3 min, 4 min, 5 min, 6 min, 7 min, 8 min, 9 min or 10 min in the embodiments of the present disclosure.

The present disclosure provides applications of the calcium-magnesium composite fireproof and flame-retardant material described in the above technical solution or the calcium-magnesium composite fireproof and flame-retardant material prepared by the preparation method described in the above technical solution in the tape of optical cable or tape of electrical cable. The calcium-magnesium composite fireproof and flame-retardant material provided by the present disclosure is prepared by steps including ball milling, mixing, coating and drying, the prepared calcium-magnesium composite fireproof and flame-retardant material has excellent mechanical properties, flame retardant properties and tensile strength, the preparation process is simple, the raw materials are easy to obtain, the environment is friendly, and the cost is low, with a good application prospect as a tape of optical cable or a tape of electrical cable.

The present disclosure provides a flame-resistant optical/electrical cable, including a matrix and the calcium-magnesium composite fireproof and flame-retardant material coated on a surface of the matrix; and the matrix includes an optical cable or an electrical cable. In the present disclosure, a material of the matrix preferably includes glass fiber cloth. A thickness of the calcium-magnesium composite fireproof and flame-retardant material is preferably 0.15-0.20 mm, which can be 0.15 mm, 0.16 mm, 0.17 mm, 0.18 mm, 0.19 mm, or 0.20 mm in the embodiments of the present disclosure.

The present disclosure provides a preparation method of the flame-resistant optical/electrical cable described in the above technical solution, including the following steps: raw materials for preparing the calcium-magnesium composite fireproof and flame-retardant material described in the above technical solution are mixed, to obtain a mixed solution, the mixed solution is coated on a matrix and then dried, to obtain the flame-resistant optical/electrical cable.

In the present disclosure, the coating preferably includes: one side of the matrix is coated and dried, and then the other side of the matrix is coated and dried. The present disclosure has no special limitation for the coating, and the calcium-magnesium composite fireproof and flame-retardant material with a thickness of 0.15-0.20 mm can be obtained by using the coating method well known by those skilled in the art.

In the present disclosure, conditions for mixing and drying are the same as the conditions for mixing and drying in the calcium-magnesium composite fireproof and flame-retardant material, which are not repeated here.

In order to further illustrate the present disclosure, in the following, the calcium-magnesium composite fireproof and flame-retardant material, the preparation method and applications thereof, and the flame-resistant optical/electrical cable and the preparation method thereof provided by the present disclosure are described in detail in combination with embodiments, but they cannot be understood as the limitation of the protection range of the present disclosure.

In the following embodiments and contrast examples, a preparation method of the biomass calcium material powder is as follows: the biomass calcium material is placed in a planetary ball mill and ball milled with water, a ball milling time is 10 h and a ball milling speed is 300 r/min, then it is frozen at −50° C. and dried to constant weight (10-24 h), to obtain biomass calcium material powder with a particle size of 40-200 m.

### Embodiment 1

Oyster shell powder 2.5 phr, magnesium hydroxide 2.5 phr, VAE latex 4 phr, water 20 phr were taken, ultrasound was performed at power of 100 W for 30 min, then being stirred in a magnetic agitator at 800 r/min for 1 h, to obtain a mixed solution; the mixed solution was coated on glass fiber cloth by a coating machine, heated at 80° C. under atmospheric pressure and dried for 5 min, then the glass fiber cloth was turned over, repeating and the above coating and drying were repeated, to obtain a fireproof and flame-retardant tape based on oyster shell/magnesium hydroxide coating.

### Embodiment 2

Oyster shell powder 1.67 phr, magnesium hydroxide 3.33 phr, VAE latex 4 phr, water 20 phr were taken, ultrasound was performed at power of 100 W for 30 min, then being stirred in a magnetic agitator at 800 r/min for 1 h, to obtain a mixed solution; the mixed solution was coated on glass fiber cloth by a coating machine, heated at 80° C. under atmospheric pressure and dried for 5 min, then the glass fiber cloth was turned over, repeating and the above coating and drying were repeated, to obtain a fireproof and flame-retardant tape based on oyster shell/magnesium hydroxide coating.

### Embodiment 3

Oyster shell powder 3.33 phr, magnesium hydroxide 1.67 phr, VAE latex 4 phr, water 20 phr were taken, ultrasound was performed at power of 100 W for 30 min, then being stirred in a magnetic agitator at 800 r/min for 1 h, to obtain a mixed solution; the mixed solution was coated on glass fiber cloth by a coating machine, heated at 80° C. under atmospheric pressure and dried for 5 min, then the glass fiber cloth was turned over, repeating and the above coating and drying were repeated, to obtain a fireproof and flame-retardant tape based on oyster shell/magnesium hydroxide coating.

### Embodiment 4

Shell powder 2.5 phr, magnesium hydroxide 2.5 phr, VAE latex 4 phr, water 20 phr were taken, ultrasound was performed at power of 100 W for 30 min, then being stirred in a magnetic agitator at 800 r/min for 1 h, to obtain a mixed solution; the mixed solution was coated on glass fiber cloth by a coating machine, heated at 80° C. under atmospheric pressure and dried for 5 min, then the glass fiber cloth was turned over, repeating and the above coating and drying were repeated, to obtain a fireproof and flame-retardant tape based on shell/magnesium hydroxide coating.

### Embodiment 5

Eggshell powder 2.5 phr, magnesium hydroxide 2.5 phr, VAE latex 4 phr, water 20 phr were taken, ultrasound was performed at power of 100 W for 30 min, then being stirred in a magnetic agitator at 800 r/min for 1 h, to obtain a mixed solution; the mixed solution was coated on glass fiber cloth by a coating machine, heated at 80° C. under atmospheric pressure and dried for 5 min, then the glass fiber cloth was turned over, repeating and the above coating and drying were repeated, to obtain a fireproof and flame-retardant tape based on eggshell/magnesium hydroxide coating.

### Contrast Example 1

The difference from Embodiment 1 was only that the magnesium hydroxide was replaced with the same amount of oyster shell powder, to obtain a fireproof and flame-retardant tape based on the oyster shell coating.

### Contrast Example 2

The difference from Embodiment 1 was only that the oyster shell powder was replaced with the same amount of magnesium hydroxide, to obtain a fireproof and flame-retardant tape based on the magnesium hydroxide coating.

### Test Example 1

### Performance Evaluation

The flame retardancy, oxygen index, gram weight and mechanical properties were tested on the tapes prepared by the embodiments and contrast examples.

### 1. Flame Retardancy Test

The determination of the oxygen index was performed on the tapes in an oxygen index tester, under the specified conditions, a minimum oxygen concentration required for flame combustion of a material in oxygen-nitrogen mixed gas flow, the lower the limiting oxygen index (LOI), the easier the material would burn.

### 2. Mechanical Properties Test

The tape was cut into 250 mm×40 mm strip-shaped samples, which were tested at 50 mm/min in a universal tensile testing machine.

TABLE 1
Performance test results of the tapes prepared
by Embodiments 1-4 and the Contrast Example 1

| | Oyster | | | | | |
|---|---|---|---|---|---|---|
| | shell/magnesium | Oxygen | Tensile | Tensile | Gram | Thickness/ |
| Sample | hydroxide ratio | index/% | strength/N | rate/% | weight/(g/m²) | mm |
| Embodiment 1 | 1:1 | 100 | 808.59 | 5.07 | 199 | 0.15-0.16 |
| Embodiment 2 | 1:2 | 100 | 650.58 | 5.12 | 211 | 0.17-0.18 |
| Embodiment 3 | 2:1 | 100 | 620.49 | 4.43 | 204 | 0.17-0.18 |
| Embodiment 4 | 1:0 | 100 | 492.70 | 3.97 | 216 | 0.16-0.17 |
| Contrast 1 | 0:1 | 100 | 315 | 3.2 | 202 | 0.18-0.20 |

It could be seen from Table 1 that the oxygen indices of the tapes prepared by Embodiments 1-4 and Contrast Example 1 all reached 100%, showing excellent flame retardancy. Especially, Embodiment 1 compounded by oyster shell and magnesium hydroxide showed the best comprehensive performance in terms of tensile strength, tensile rate, weight and thickness under a condition of maintaining a 100% oxygen index.

TABLE 2
Performance test results of the tapes prepared by Embodiments 4-6

| | Biomass | Oxygen | Tensile | Tensile | Gram | Thickness/ |
|---|---|---|---|---|---|---|
| Sample | calcium | index/% | strength/N | rate/% | weight/(g/m²) | mm |
| Embodiment 4 | oyster | 100 | 492.7 | 3.97 | 216 | 0.16-0.17 |
| | shells | | | | | |
| Embodiment 5 | shell | 78 | 420.18 | 3.5 | 219 | 0.19-0.21 |
| Embodiment 6 | eggshell | 80 | 425.5 | 3.31 | 211 | 0.18-0.20 |

It could be seen from Table 2 that the oxygen index of Embodiment 5-6 was slightly lower than that of Embodiment 4, and the tensile strength, tensile rate, gram weight and thickness of Embodiment 5-6 were also slightly lower than that of Embodiment 4. Therefore, based on the comprehensive performance of the prepared flame-retardant tapes, Embodiment 4 with oyster shell as a main raw material had the characteristics of high tensile strength, low weight and high flame retardant.

The above descriptions are only the preferred embodiments of the present disclosure. It is to be pointed out that those of ordinary skill in the art can also make several improvements and modifications without departing from the principle of the present disclosure, and such improvements and modifications shall fall within the protection scope of the present disclosure.

What is claimed is:

1. A calcium-magnesium composite fireproof and flame-retardant material, comprising raw materials, in weight parts, as follows: 1-10 phr of a biomass calcium material, 1-10 phr of magnesium hydroxide, 2-8 phr of a vinyl acetate-ethylene (VAE) latex, and 10-30 phr of water.

2. The calcium-magnesium composite fireproof and flame-retardant material according to claim 1, wherein the biomass calcium material comprises one or more of a shell, an oyster shell, and an eggshell;
the biomass calcium material is crushed and dried before use to obtain a biomass calcium material powder; and
a particle size of the biomass calcium material powder is 40-200 μm.

3. A preparation method of the calcium-magnesium composite fireproof and flame-retardant material according to claim 1, comprising the following steps: mixing the raw materials to obtain a mixed solution, and drying the mixed solution to obtain the calcium-magnesium composite fireproof and flame-retardant material.

4. The preparation method according to claim 3, wherein the mixing comprises an ultrasonic mixing or a stirring mixing;
a time of the ultrasonic mixing is 20-40 min, and a power of the ultrasonic mixing is 20-100 W; and
a time of the stirring mixing is 30-90 min, and a speed of the stirring mixing is 200-800 r/min.

5. The preparation method according to claim 3, wherein a drying temperature is 60-100° C.

6. The calcium-magnesium composite fireproof and flame-retardant material according to claim 1, wherein the calcium-magnesium composite fireproof and flame-retardant material is used in a tape of an optical cable or a tape of an electrical cable.

7. A flame-resistant optical/electrical cable, comprising a matrix and the calcium-magnesium composite fireproof and flame-retardant material according to claim 1; wherein the calcium-magnesium composite fireproof and flame-retardant material is coated on a surface of the matrix; and the matrix comprises an optical cable or an electrical cable.

8. A preparation method of the flame-resistant optical/electrical cable according to claim 7, comprising the following steps:
mixing the raw materials for preparing the calcium-magnesium composite fireproof and flame-retardant material to obtain a mixed solution, and coating the mixed solution on the matrix and then drying to obtain the flame-resistant optical/electrical cable.

9. The preparation method according to claim 8, wherein the mixing comprises an ultrasonic mixing or a stirring mixing;
a time of the ultrasonic mixing is 20-40 min, and a power of the ultrasonic mixing is 20-100 W; and
a time of the stirring mixing is 30-90 min, and a speed of the stirring mixing is 200-800 r/min.

10. The preparation method according to claim 8, wherein a drying temperature is 60-100° C.

11. The preparation method according to claim 3, wherein in the calcium-magnesium composite fireproof and flame-retardant material, the biomass calcium material comprises one or more of a shell, an oyster shell, and an eggshell;
the biomass calcium material is crushed and dried before use to obtain a biomass calcium material powder; and
a particle size of the biomass calcium material powder is 40-200 μm.

12. The calcium-magnesium composite fireproof and flame-retardant material according to claim 2, wherein the calcium-magnesium composite fireproof and flame-retardant material is used in a tape of an optical cable or a tape of an electrical cable.

13. The flame-resistant optical/electrical cable according to claim 7, wherein in the calcium-magnesium composite fireproof and flame-retardant material, the biomass calcium material comprises one or more of a shell, an oyster shell, and an eggshell;
the biomass calcium material is crushed and dried before use to obtain a biomass calcium material powder; and
a particle size of the biomass calcium material powder is 40-200 μm.
